(19) United States
(12) Patent Application Publication
(10) Pub. No.: US 2019/0358654 A1
(43) Pub. Date: Nov. 28, 2019

(54) Detachable Shower Head with Therapeutic Fluid Dispensement Means

(71) Applicant: Michael J. Stanton, Las Vegas, NV (US)

(72) Inventor: Michael J. Stanton, Las Vegas, NV (US)

(21) Appl. No.: 15/990,609

(22) Filed: May 26, 2018

(51) Int. Cl. B05B 1/18; B05B 7/24

(52) U.S. Cl. CPC B05B 1/18; B05B 7/24

(57) ABSTRACT

A detachable shower head assembly having a canister for combining an additive with water input to the shower head assembly. The canister may separate into cylindrical halves allowing introduction of the additive. Alternatively, the canister may be fit with a watertight door providing access to an interior chamber adapted to dissolve, emulsify, or mix the additive with input water.

### FIELD OF THE INVENTION

This invention relates to shower heads and bathing products, and more particularly relates to improved shower head attachment means for dispensing therapeutic compositions.

### BACKGROUND

### Description of the Related Art

The use of shower heads to spray pressurized shower water over a user's body for hygienic purposes is well known in the art, including detachable shower heads with rotatable turrets for selectively forcing show water through a plurality of nozzle arrangements. Typically, persons showering separately apply soap, shampoo, conditioners, moisturizers, body wash, and/or other hygienic compositions over their body by hand while showering.

Certain apparat for adding or removing deposits from shower water are known in the art, including descaling apparati and apparati for removing metal cations such ion-exchange devices (i.e., water softeners) used to reduce limescale and calcium. However, efficient detachable shower heads adapted to dispense any one of a plurality of therapeutic compositions on an ad hoc basis are unknown in the art.

The prior art does teach or suggest the herein provided inventive method steps and elements arranged and configured. It is an object of the present invention, through a new, useful and unobvious combination of component elements, to provide efficient means of selectively dispensing therapeutic compositions from a shower head in shower water.

These objects should be construed exemplary on non-limiting. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY

From the foregoing discussion, it should be apparent that a need exists for a detachable shower head with therapeutic fluid dispensing means. Beneficially, such a device would overcome inefficiencies with the prior art by providing a rapid access canister with therapeutic fluid or solid retaining means.

The present invention has been developed in response to the present state of the art, and in particular, in response to the problems and needs in the art that have not yet been fully solved by currently available apparti. Accordingly, the present invention has been developed to provide a detachable shower head assembly comprising rapid fluid dispensing means, the shower head assembly comprising: a cylindrical canister defining a hollow interior recess for receiving a therapeutic additive, the cylindrical canister comprising: a first half cylinder exteriorly-threaded; a second half cylinder interiorly-threaded to rotatably engage the first half cylinder; a first interiorly-threaded fitting for affixing the canister to a water pipe; and a second interiorly-threaded fitting for affixing the canister to a shower head.

The additive may be combined with water dispensed from the shower head. The detachable shower head assembly may further comprise a tapering conduit for reducing water pressure to a shower head.

The additive may further comprise one of a dissoluble solid and a liquid.

The additive may alternatively comprise one of a soap, a moisturizer, a bath oil, and fragrance. In various embodiments, the canister further defines an interior conduit for communicating water to an interior chamber.

The conduit may be tapered to reduce water pressure. In various embodiments, the detachable shower head assembly further comprises a spherical interior chamber for combining the additive with input water.

The first interiorly-threaded fitting may be affixed to the first half cylinder.

The second interiorly-threaded fitting may be affixed to the first half cylinder.

A second detachable shower head assembly comprising rapid fluid dispensing means is provided, the shower head assembly comprising: a cylindrical canister defining a hollow interior recess for receiving a therapeutic additive, the cylindrical canister comprising: a first half cylinder exteriorly-threaded; a second half cylinder interiorly-threaded to rotatably engage the first half cylinder; a first interiorly-threaded fitting for affixing the canister to a water pipe; and a second interiorly-threaded fitting for affixing the canister to a shower head; a tapered interior conduit for directing water to an interior chamber and reducing water pressure; and an interior chamber for receiving the additive.

The additive may be combined with water dispensed from the shower head.

The detachable shower head assembly may further comprise a tapering conduit for reducing water pressure to a shower head.

The additive may comprise one of a dissoluble solid and a liquid.

The additive may further comprise one of a soap, a moisturizer, a bath oil, and fragrance. The detachable shower head assembly may further comprise a second conduit for directing combined water and additive to a shower head.

The first and second conduits may be S-shaped.

A detachable shower head assembly comprising rapid fluid dispensing means is also provided, the shower head assembly comprising: a canister defining a hollow interior recess for receiving a therapeutic additive to the interior recess, the cylindrical canister comprising a watertight door for facilitating introduction of the additive, wherein the interior recess is adapted to allow combination of the additive with pressurized water entering the interior chamber.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward side perspective view of a detachable shower head assembly in accordance with the prior art;

FIG. 2 is a forward side perspective view of a detachable shower head having therapeutic fluid dispensing means in accordance with the present invention;

FIG. 3A is a side perspective view of a detachable shower head having therapeutic fluid dispensing means in accordance with the present invention;

FIG. 3B is a side perspective view of a detachable shower head dispenser in accordance with the present invention;

FIG. 4 is a partially-sectioned side perspective view of a detachable shower head dispenser in accordance with the present invention; and

FIG. 5 is a sectioned side perspective view of a canister of detachable shower head dispenser in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, elements well-known to those of skill in the art are not shown or described in detail to avoid obscuring aspects of the invention.

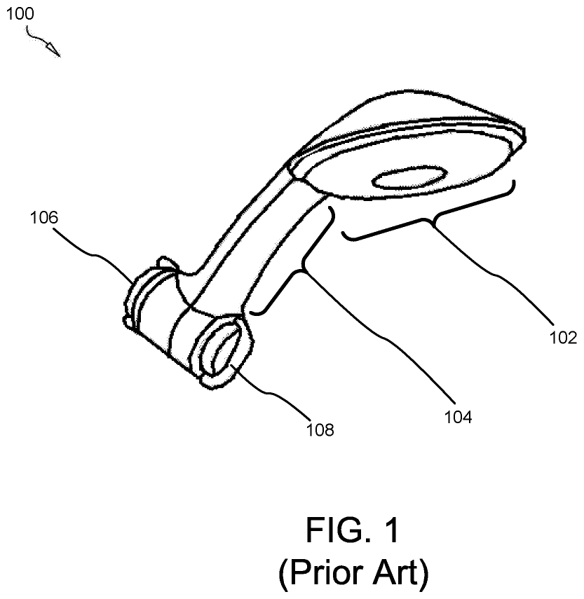

FIG. 1 is a forward side perspective view of a detachable shower head assembly 100 in accordance with the prior art.

The shower head assembly 100 affixes detachably to a threaded water pipe using the interiorly-threaded socket or fitting 106. The shower head 102 dispenses Wt pressurized water from a plurality of nozzles usually in a uniform pattern.

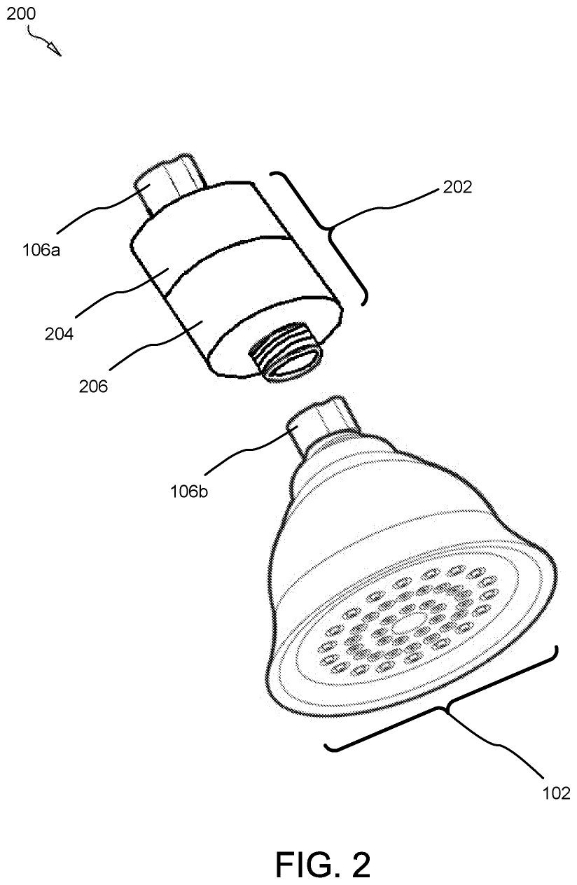

FIG. 2 is a forward side perspective view of a detachable shower head having therapeutic fluid dispensing means 200 in accordance with the present invention.

A fluid dispensing shower head 102 is affixed to a canister 202 (or container) which may comprise a mechanical two-way valve or a mechanical one-way valve. Pressurized water flows into the canister mixing with the additive inserted, forming a composition, mixture, solution, emulsion, or colloid between the pressurized water and the additive which is ejecting, or dispensed, under pressure form the shower head 102.

Within the canister 202, as water flow is directed past an additive in the water flow conduit of the canister 202, the additive is dissolved, mixed or emulsified with the pressurized water and dispensed in roughly uniform concentrations over a user in a shower.

The shower head 200 enables soaps, lotions, essential oils, fragrances, bath oils and the like to be emulsified, dissolved in, mixed or otherwise combined with the dispensed water. The canister 202 may comprise an indicator approximating the content level remaining of an additive 402 inserted into the canister 202.

The apparatus 200 comprises a canister 202 having a fitting or socket 106a for receiving an exteriorly-threaded water supply pipe. The canister 202 defines a chamber for housing a user-added additive. The canister 202 may, but not necessarily, define a narrowing water passageway using Venturi force to reduce water pressure.

The chamber is adapted to combine the additive and input water and communicates between the exterior of the shower head and the interior of the canister 202. One or more interior valves may be adapted to adjust the rate of flow of pressurized water through the canister 202 to allow predetermined dissolution or emulsification of the additive in the dispensed water. The volume of the canister 202 may likewise be adapted to facilitate optimized combination of the additive with dispensed water.

It is, therefore, an object of this invention to provide an apparatus for rapid introduction of an additive 402 introduced to the canister 202 into a stream of water being Mt dispensed from a shower head 102.

The canister 202 in the shown embodiment comprises a cylindrical body split into threadably-engagable half cylinders 204, 206 screwed together. The half cylinders 204, 206 are detachable from one another to allow rapid insertion of an additive, either in liquid or solid form, into the recess 404 (further described below) defined by the canister 202.

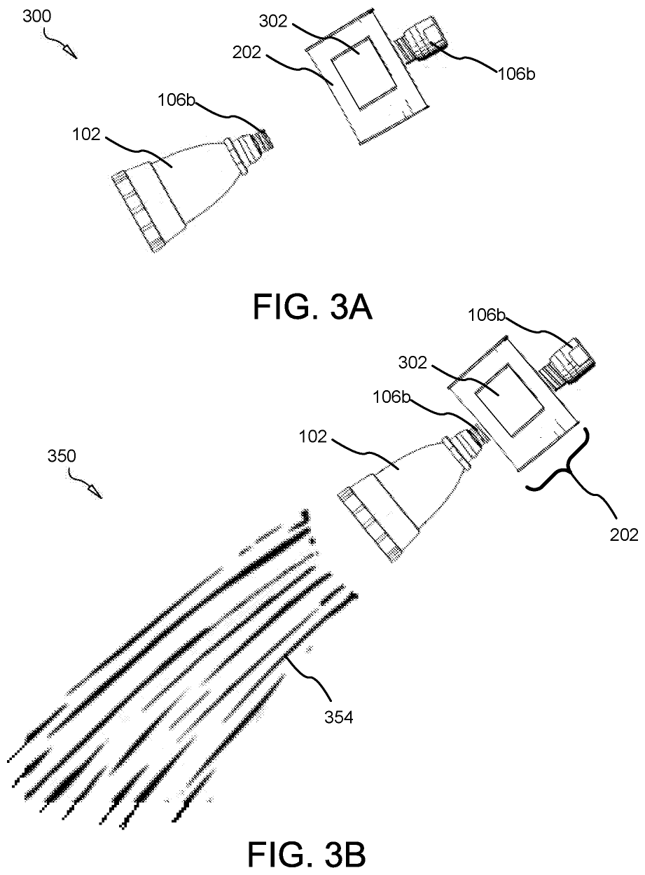

FIG. 3A is a side perspective view of a detachable shower head assembly having therapeutic fluid dispensing means 300 in accordance with the present invention.

The assembly 300 comprises a cylindrical canister 202 as shown, which be cubic, spherical or otherwise-shaped in alternative embodiments. Unlike apparatus 200, the assembly 300 does not comprise half cylinders 204, 206. Rather, the assembly 300 comprises a door 302 which affixes in a closed position using means known to those of the skill in the art. The door 302 provides means for inserting and removing one or more additives 402 from the canister 202.

FIG. 3B is a side perspective view of a detachable shower head dispenser 350 in accordance with the present invention.

Dispensed water 354 is ejected from the shower head 102.

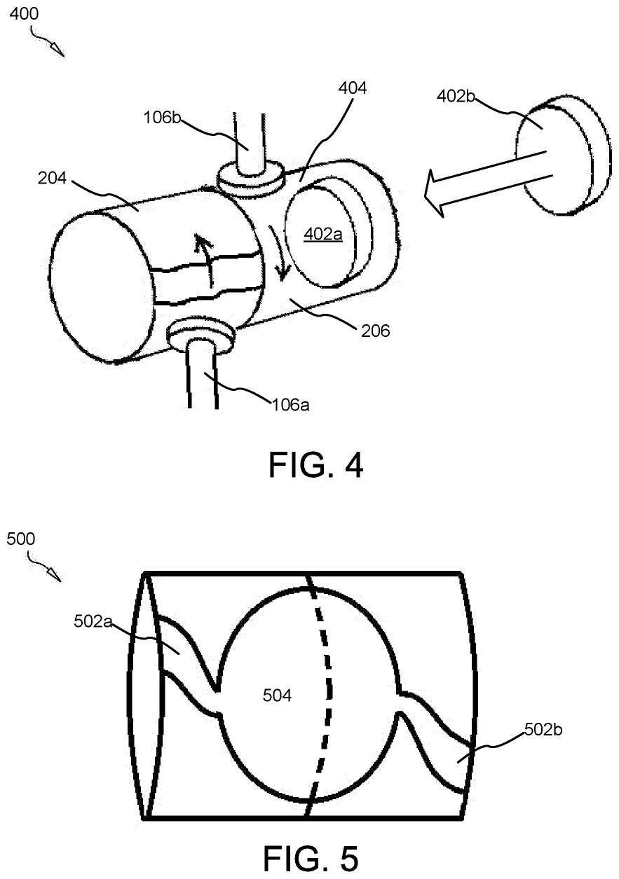

FIG. 4 is a partially-sectioned side perspective view of a detachable shower head dispenser 400 in accordance with the present invention.

The additive 402 may be colloidally suspended and existing heterogeneously in the solution 100 or homogeneously combined with the dispensed water in a concentration predetermined to provide maximum appeal to a user.

The additive 402 may comprise a surfactant for dissolving hydrophobic compounds additive 402. The additive 402 may comprise a colorant indicating concentration. The additives 402a-b may comprise cylindrical tablets. A user may selectively add one or more additives 402 to the canister 202 to increase or decrease concentrations or to mix additives 402 of various species.

The half cylinders 204, 206 counterrotate to engage one another threadably.

FIG. 5 is a sectioned side perspective view of a canister 500 of detachable shower head dispenser in accordance with the present invention. The canister 500 is cylindrical and comprises two tapered conduits 502a-b. The conduit 502a tapers to reduce water pressure to the chamber 504. Both conduits are S-shaped but may be shaped in any form. The conduit may snake around within the canister 500 in boustrophedon manner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detachable shower head assembly comprising rapid fluid dispensing means, the shower head assembly comprising:
a cylindrical canister defining a hollow interior recess for receiving a therapeutic additive, the cylindrical canister comprising:
a first half cylinder exteriorly-threaded;
a second half cylinder interiorly-threaded to rotatably engage the first half cylinder;
a first interiorly-threaded fitting for affixing the canister to a water pipe; and
a second interiorly-threaded fitting for affixing the canister to a shower head.

2. The detachable shower head assembly of claim 1, wherein the additive is combined with water dispensed from the shower head.

3. The detachable shower head assembly of claim 1, further comprising a tapering conduit for reducing water pressure to a shower head.

4. The detachable shower head assembly of claim 1, wherein the additive comprises on of a dissoluble solid and a liquid.

5. The detachable shower head assembly of claim 1, wherein the additive comprises one of a soap, a moisturizer, a bath oil, and fragrance.

6. The detachable shower head assembly of claim 1, wherein the canister further defines an interior conduit for communicating water to an interior chamber.

7. The detachable shower head assembly of claim 6, wherein the conduit is tapered to reduce water pressure.

8. The detachable shower head assembly of claim 6, further comprising a spherical interior chamber for combining the additive with input water.

9. The detachable shower head assembly of claim 1, wherein the first interiorly-threaded fitting is affixed to the first half cylinder.

10. The detachable shower head assembly of claim 1, wherein the second interiorly-threaded fitting is affixed to the first half cylinder.

11. A detachable shower head assembly comprising rapid fluid dispensing means, the shower head assembly comprising:
a cylindrical canister defining a hollow interior recess for receiving a therapeutic additive, the cylindrical canister comprising:
a first half cylinder exteriorly-threaded;
a second half cylinder interiorly-threaded to rotatably engage the first half cylinder;
a first interiorly-threaded fitting for affixing the canister to a water pipe; and
a second interiorly-threaded fitting for affixing the canister to a shower head;
a tapered interior conduit for directing water to an interior chamber and reducing water pressure; and
an interior chamber for receiving the additive.

12. The detachable shower head assembly of claim 1, wherein the additive is combined with water dispensed from the shower head.

13. The detachable shower head assembly of claim 1, further comprising a tapering conduit for reducing water pressure to a shower head.

14. The detachable shower head assembly of claim 1, wherein the additive comprises on of a dissoluble solid and a liquid.

15. The detachable shower head assembly of claim 1, wherein the additive comprises one of a soap, a moisturizer, a bath oil, and fragrance.

16. The detachable shower head assembly of claim 1, further comprising a second conduit for directing combined water and additive to a shower head.

17. The detachable shower head assembly of claim 1, wherein the first and second conduits are S-shaped.

18. A detachable shower head assembly comprising rapid fluid dispensing means, the shower head assembly comprising:
a canister defining a hollow interior recess for receiving a therapeutic additive to the interior recess, the cylindrical canister comprising a watertight door for facilitating introduction of the additive, wherein the interior recess is adapted to allow combination of the additive with pressurized water entering the interior chamber.
